(19) United States
(12) Patent Application Publication
(10) Pub. No.: US 2018/0017049 A1
(43) Pub. Date: Jan. 18, 2018

(54) COMPRESSOR HOUSING HAVING PRESSURE LIMITATION, AND METHOD FOR OPERATION

(71) Applicant: Magna Powertrain Bad Homburg GmbH, Bad Homburg (DE)

(72) Inventors: Jan HINRICHS, Friedrichsdorf (DE); Said JENNAOUI, Frankfurt (DE); Johannes GROSS, Aschaffenburg (DE)

(21) Appl. No.: 15/544,591

(22) PCT Filed: Jan. 5, 2016
(86) PCT No.: PCT/EP2016/050071

§ 371 Date: Jul. 19, 2017

(30) Foreign Application Priority Data
Jan. 26, 2015 (DE) 10 2015 201 291.3

(51) Int. Cl. F04B 39/12; F16B 31/06; F04B 37/18

(52) U.S. Cl. CPC F04B 39/121; F04B 37/18; F16B 31/06

(57) ABSTRACT

A housing of an air-conditioning compressor comprising at least two housing components is proposed, wherein the at least two housing components are sealed with respect to each other and are connected to each other by means of screws, and the housing components comprise aluminum or an aluminum alloy and the screws are ultra-high-strength screws. UHS screws are means for further ensuring an excess pressure safety function.

### CROSS-REFERENCE TO RELATED APPLICATIONS

This application is a National Stage of International Application No. PCT/EP2016/050071, filed Jan. 5, 2016 which claims priority to German Application No. 10 2015 201 291.3 filed Jan. 26, 2015. The entire disclosure of each of the above applications is incorporated herein by reference.

### FIELD

The invention relates to a compressor housing having pressure limitation according to the preamble of claim 1, and a method for operating a refrigerant compressor.

### BACKGROUND

This section provides information related to the present disclosure which is not necessarily prior art.

Housing components of compressors, as used, for example, in air-conditioning units of vehicles, are configured in such a manner that they generally withstand double the maximum operating pressure without bursting. The maximum operating pressure is determined by means of a pressure limitation element. Different embodiments of pressure limitation element are known. A distinction should be made between housing components with pressure chambers which are acted on with suction pressure (low pressure) or with output pressure (high pressure). The invention relates to housing components which are acted on with low pressure. The pressure limitation element which is relevant for the pressure protection is generally constructed outside the compressor in the refrigerating circuit, ideally where the low pressure is produced. This is the expansion member.

There are used as connection elements of the housing components screws which withstand the forces acting in the event of bursting. With compressors for operation with the refrigerant R744, as a result of the higher pressures during operation, the screwing forces are significantly greater than during operation with the refrigerant R134a, consequently screws with a larger thread diameter are required. The screw forces lead locally to high deformations and consequently tensions, in particular with aluminum housings which are optimized in terms of wall thickness and therefore weight.

Ultra-high-strength screw connections are known, for example, from DE 102008041391A1 and standardized in accordance with the strength class 14.8//15.8//16.8 according to VDA 235-205. Ultra-high-strength screws are defined by their material quality, wherein the screws may be present in the pretensioned state. With the use of ultra-high-strength screws, fewer screws are required with the same force connection or screws with smaller dimensions can be used. This affords advantages in terms of structural space and weight. This leads to cost savings with all connections.

WO 9956019A1 discloses a hydraulic pump which enables an internal pressure limitation. In this instance, a cover which is arranged in a housing is secured to a flange using screws and the screws are pretensioned in such a manner that from a selected pressure the cover lifts by a crack and the excess pressure is thus reduced. There is no leakage to the outer side in this instance.

### SUMMARY

This section provides a general summary of the disclosure, and is not a comprehensive disclosure of its full scope of all of its features.

An object of the invention is to provide a housing for an air-conditioning compressor which is constructed with a lightweight construction and which enables an additional excess pressure reduction without destruction.

This object is achieved with a housing of an air-conditioning compressor comprising at least two housing components, wherein the at least two housing components are sealed with respect to each other and are connected to each other by means of screws, wherein the housing components comprise aluminum and/or an aluminum alloy and the screws are ultra-high-strength screws.

It is advantageous when there is a sufficiently high surface pressure between the housing components to prevent lifting of the flanges.

It may also be advantageous for a resilient seal to be constructed between the housing components.

It is advantageous for the walls of the housing components in the region of the flat seal to be on average less than 10 mm thick. For comparison, the wall with R134a is 4-5 mm thick. The compressor according to the invention has a wall thickness of 7-8 mm in the region of the flat seals. The housing has considerably different wall thicknesses from the region of the screw head support to the region of the flat seal. The clamped cylinder block is constructed as a massive plate and the cylinder head which contains the threaded blind holes again has thin walls.

In this instance, screws are preferably ultra-high-strength screws of the strength class 14.8//15.8//16.8 according to VDA 235-205.

Advantageously, the screws have a diameter of M7 or M8 mm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of the exemplary embodiment,

FIG. 2 shows further details.

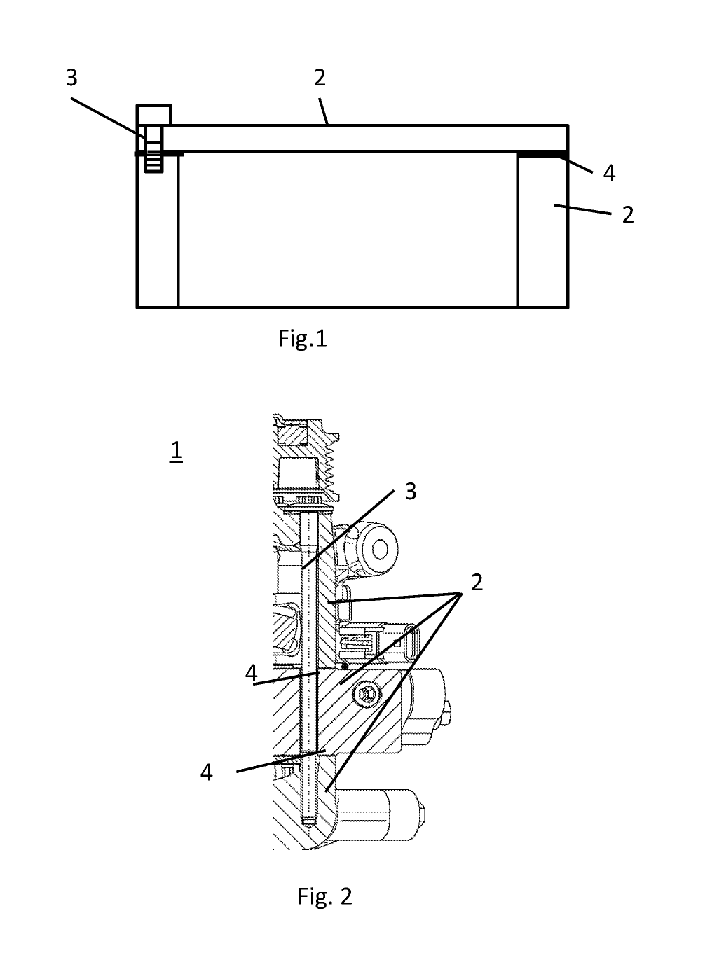

### DETAILED DESCRIPTION

Example embodiments will now be described more fully with reference to the accompanying drawings.

The air-conditioning compressor 1 according to the invention comprises housing components 2 which are connected to each other by means of ultra-high-strength screws 3. In this instance, a variant the connection of two housing components or a plurality of housing components is configured as in FIG. 2 with a screw 3 which extends almost over the structural height of the compressor. The housing component and the connections and seals thereof when R744 is used must withstand up to 100 bar internal pressure.

The housing components 2 are positioned one on the other with flat seals 4 in a state sealed relative to each other. In order to achieve uniform pressing of the flat seal, the number of screws corresponds to at least that of the pistons since they are arranged between the pistons when a piston compressor is used. With piston numbers less than 6, a plurality of screws between the pistons are also conceivable.

The use of ultra-high-strength screws and the configuration of the screw connection is carried out in such a manner that, when a defined pressure is exceeded, the surface pressure of the flat seals between the housing components is not sufficient to seal so that leakage occurs and consequently no further significant pressure increase occurs. Consequently, there is produced a safety function which acts as an additional function to other excess pressure components or as an individual safety function. In contrast to the use of standard screws, UHS screws as a result of their greater elongation at rupture and their higher apparent yielding point enable a reversible behavior of the described pressure limitation device.

The screws are intended to be configured in such a manner that they withstand the bursting pressure so that component and assembly tolerances can be absorbed in order to be able to ensure the described safety function. The bursting pressure should be above the response pressure of the safety function by a factor of from 1.1 to 1.8.

Bainitically quenched and tempered screws (UHS screws) have high elongations at rupture with high strengths. It is thereby possible to configure in particular screw connections with large clamping lengths and different material pairings and thermal expansion. Housing components of aluminum are thus connected using the ultra-high-strength steel screw.

When ultra-high-strength screws are used, the screw diameter may be selected to be smaller than with standard screws. The ultra-high-strength screw is thereby softer than a standard screw of lower strength and accordingly larger diameter. As a result of the smaller thread diameter, the ultra-high strength screw must absorb lower mechanical and thermal auxiliary screwing forces, which at the same time leads to a low loading of the housing in the screw head support region and in the nut thread.

The advantages when ultra-high-strength screws are used to connect housing components of a refrigerant compressor are in this instance the smaller structural space as a result of the smaller diameter of the ultra-high-strength screws, the higher level of resilience thereof and the lower weight of the entire subassembly.

During operation of the refrigerant compressor, it is important that, with housing components of aluminum or an aluminum alloy in combination with ultra-high-strength screws, a reversible pressure limitation function can be represented by relieving the separation joint between the housing components in order to reduce pressures between the maximum operating pressure and the bursting pressure.

### LIST OF REFERENCE NUMERALS

1 Compressor

2 Housing components

3 Screw

4 Flat seal

1. A housing of a refrigerant compressor comprising at least two housing components, wherein the at least two housing components are sealed with respect to each other and are connected to each other by means of screws, characterized in that the housing components comprise aluminum or an aluminum alloy and are connected to each other by means of ultra-high-strength screws.

2. The housing as claimed in claim 1, wherein there is a surface pressure between the housing components.

3. The housing as claimed in claim 1, wherein a resilient seal is constructed between the housing components.

4. The housing as claimed in claim 1, wherein a flat seal is constructed between the housing components.

5. The housing as claimed in claim 4, wherein the walls of the housing components in the region of the screw connection in the region of the flat seal are less than 10 mm thick.

6. The housing as claimed in claim 1, wherein the screws ultra-high-strength screws of the strength class 14.8//15.8//16.8 according to VDA 235-205.

7. The housing as claimed in claim 1, wherein a refrigerant used in the refrigerant compressor is R744.

8. The housing as claimed in claim 3, wherein the housing and the seal are configured for a pressure range of up to 100 bar.

9. The housing as claimed in claim 1, wherein the screws have a diameter of 7 or 8 mm.

10. A method for operating a refrigerant compressor as claimed in claim 1, wherein, with the housing components of aluminum or an aluminum alloy in combination with the ultra-high-strength screws, a reversible pressure limitation function is provided by relieving the separation joint between the housing components in order to reduce pressures between a maximum operating pressure and a bursting pressure.
